(19) United States
(12) Patent Application Publication
(10) Pub. No.: US 2012/0000693 A1
(43) Pub. Date: Jan. 5, 2012

(54) ELECTRIC COIL

(75) Inventors: Jin Goon Yoon, Suwon-si (KR); Chang Hee Song, Incheon (KR); Byong Young Jeong, Incheon (KR); Bong Jik Kim, Incheon (KR); Su Jin Jeon, Incheon (KR)

(73) Assignee: SPG LTD, Incheon (KR)

(21) Appl. No.: 12/682,033

(22) PCT Filed: Jan. 21, 2010
(86) PCT No.: PCT/KR2010/000381

§ 371 Date: Apr. 7, 2010

(30) Foreign Application Priority Data
Jan. 22, 2009 (KR) 20-2009-0000813

(51) Int. Cl. H01B 7/00

(52) U.S. Cl. 174/110 R

(57) ABSTRACT

Provided is an electric coil including a wire coated with enamel and spirally wound a predetermined number of times, an insulating member, and an installation member made of plastic, wherein the wire is an aluminum wire coated with enamel and a copper wire is connected to both ends of the aluminum wire such that the electric coil used in an electric motor is formed of an aluminum wire to solve the problems of high cost and weight caused by the use of a conventional copper wire and the problems of corrosion and disconnection caused by the use of a conventional aluminum wire.

### TECHNICAL FIELD

The present invention relates to an electric coil, and more particularly, to an electric coil which is formed of an alternative material and has excellent durability and excellent corrosion resistance.

### BACKGROUND ART

The present invention provides an electric coil used in an electric motor. In particular, the present invention aims at providing an electric coil used in an electric motor, which is configured with an aluminum wire to solve the problems of high cost and weight caused by the use of a conventional copper wire.

Generally, the electric coil employed in the electric motor comprises a copper wire 1 having excellent conductivity, which is coated with enamel and spirally wound a predetermined number of times, an insulating member (not shown), an installation member B made of plastic, and terminals fixed to the installation member B.

However, since this electric coil is formed of the copper wire 1 having excellent conductivity, its manufacturing cost is very high, which increases the manufacturing cost of the electric motor.

Meanwhile, the electrical conductivity is in the order of silver>copper>gold>aluminum>magnesium>zinc>iron>lead>antimony.

Accordingly, the copper wire 1 is typically used in the manufacturing of the conventional electric coil because the copper wire 1 has low resistivity and low heat generation rate as well as excellent electrical conductivity compared to the other materials.

Although the silver has an electrical conductivity higher than that of the copper, the silver is less used due to its high cost.

For example, since Korea depends entirely on imports for copper, if domestic or foreign copper demand is strong or in the event of metal price fluctuations, it causes the problem of increased cost, which also increases the manufacturing cost of the electric coil using the copper wire.

Therefore, in order to solve the cost problem of the copper wire used in the electric coil, the necessity for manufacturing an electric coil which is very inexpensive and relatively light (its specific gravity is one-third of copper) compared to copper is raised.

If an aluminum wire is welded directly to a terminal, it is easily disconnected. Further, even though the aluminum wire is welded to the terminal, its reliability cannot be ensured due to corrosion occurring at the connection point with the terminal during a salt spray test or galvanic test, and thus it is difficult to use the aluminum wire as a coil wire.

### DISCLOSURE

### Technical Problem

The present invention has been made in an effort to solve the above-described problems associated with prior art, and an object of the present invention is to provide an electric coil used in an electric motor, which comprises an aluminum wire including at least two coils and connected in parallel to each other to reduce the high resistance of a conventional aluminum coil to be equal to that of a copper coil, thereby solving the problem of heat generation.

### Technical Solution

In one aspect, the present invention provides an electric coil including a wire coated with enamel and spirally wound a predetermined number of times, an insulating member, and an installation member made of plastic, wherein the wire may be an aluminum wire coated with enamel, and a copper wire may be connected to both ends of the aluminum wire.

The connecting part between the aluminum wire and the copper wire may be covered inside the electric coil with an insulating tube and an insulating tape, thus preventing the connecting part from being exposed to the air.

The copper wire may include an insulation coating for coating its conductive wire.

The connecting part between the aluminum wire and the copper wire may be strongly fixed by at least a solder, an insulating tube, and a lap joint.

The copper wire may be connected to a plurality of terminals, respectively, fixed to both sides of the installation member.

### Advantageous Effects

Conventionally, if an aluminum wire is welded directly to a terminal, it is easily disconnected and, even though the aluminum wire is welded to the terminal, its reliability cannot be ensured due to corrosion occurring at the connection point with the terminal during a salt spray test or galvanic test, and thus it is difficult to use the aluminum wire as a coil wire. However, according to the present invention, the electric coil is manufactured in such a manner that an aluminum wire is provided and a copper wire is connected to both ends of the aluminum wire, and thereby it is possible to solve this problem.

### DESCRIPTION OF DRAWINGS

FIG. 1 is a schematic diagram of a conventional electric coil comprising a copper wire.

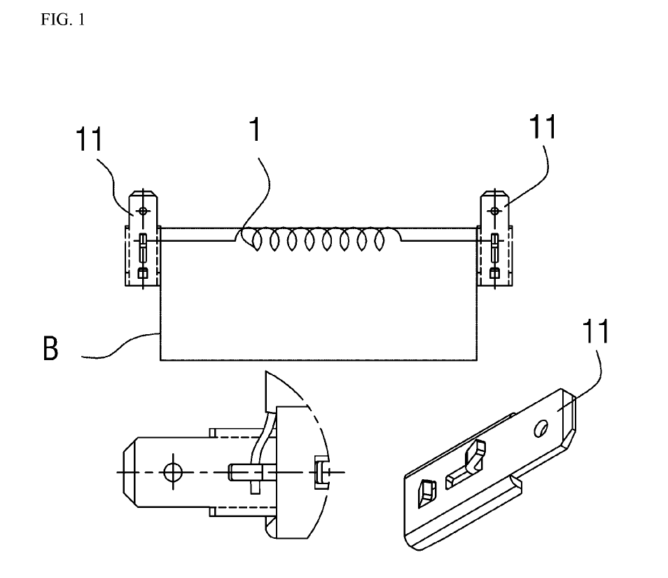

FIG. 2 is a schematic diagram of an electric coil according to an exemplary embodiment of the present invention.

FIG. 3 is a schematic diagram showing a state in which an aluminum wire and a copper wire in FIG. 2 are connected by a lap joint.

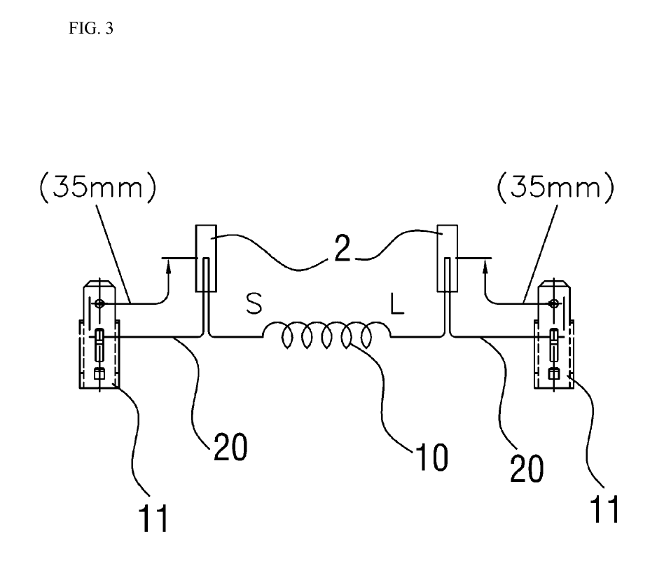

FIG. 4 is a schematic diagram showing a state in which the aluminum wire in FIG. 2 is used as a start coil and the copper wire in FIG. 2 is used as a last coil for wire coating.

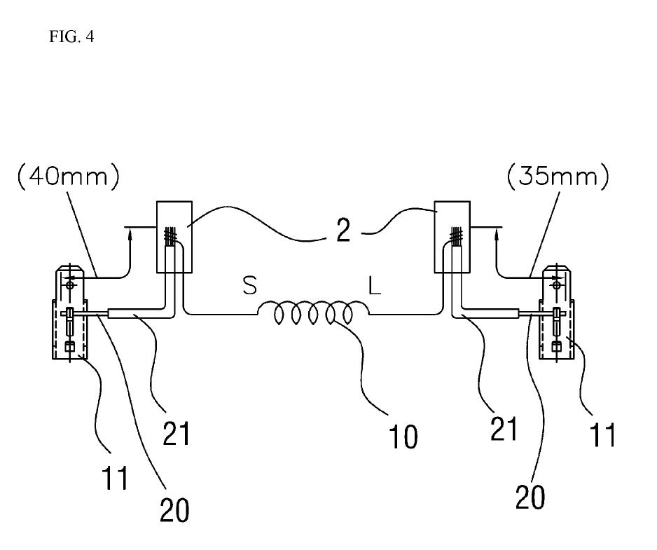

FIG. 5 is a schematic diagram showing a state in which a thermal protector (T/P) is employed in the present invention.

### MODE FOR INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

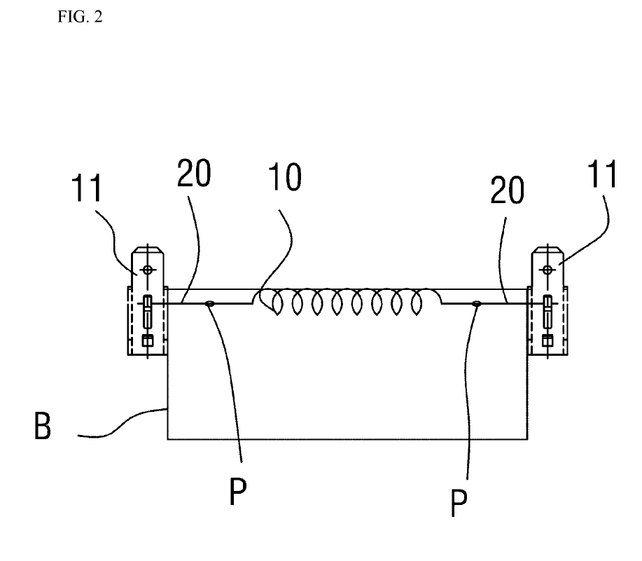

FIG. 2 is a schematic diagram of an electric coil according to an exemplary embodiment of the present invention. As shown in FIG. 2, the electric coil of the present invention comprises a wire coated with enamel and spirally wound a predetermined number of times, an insulating member (not shown), and an installation member B made of plastic.

In detail, the electric coil according to the present invention comprises an aluminum wire 10 as a start coil coated with enamel and a copper wire 20 as a last coil connected to both ends of the aluminum wire 10.

The copper wire 20 includes an insulation coating 21 for coating its conductive wire.

The connecting part between the aluminum wire 10 and the copper wire 20 is strongly fixed by at least a solder P, an insulating tube, and a lap joint 2.

The copper wire 20 is connected to a plurality of terminals 11, respectively, fixed to both sides of the installation member B.

Here, the aluminum wire 10 as a start coil may be welded to the terminals 11 with the copper wire 20 as a last coil interposed therebetween, or each of both ends of the copper wire 20 may be connected to a thermal protector (T/P), and the T/P may be welded to the terminals 11.

Moreover, the connecting part between the aluminum wire 10 and the copper wire 20 is covered inside the electric coil with an insulating tube and an insulating tape, thereby preventing the connecting part from being exposed to the air.

If the finishing work is carried out only by the copper wire 20, the aluminum wire 10 and the copper wire 20 are soldered together and covered with the insulating tube or the lap joint 2, and the copper wire 20 is welded to the terminals 11.

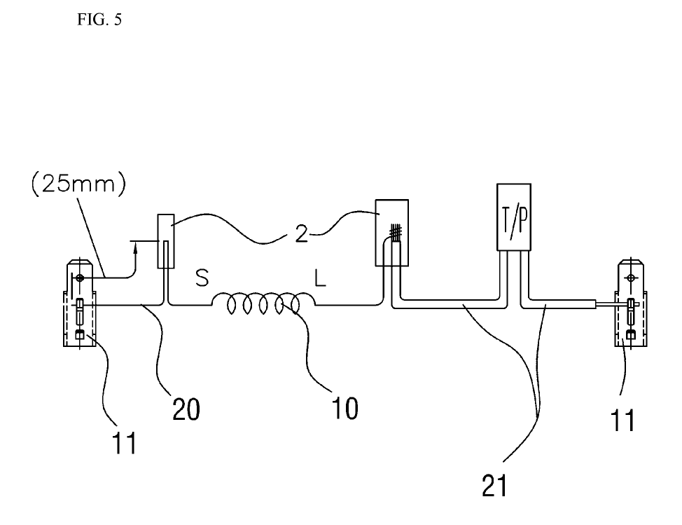

Of course, as shown in FIG. 5, the copper wire 20 as the last coil may be connected to the T/P, and the T/P wire may be welded to the terminals 11.

Here, the copper wire 20 coated with the coating 21 and the aluminum wire 10 may be soldered together, and the copper wire 20 covered with a protective insulating tube and coated with the coating 21 may be welded to the terminals 11.

Otherwise, the copper wire as the last coil may be connected to the T/P, and the T/P may be welded to the terminals 11.

As such, in the case where the electric coil used in the electric motor is configured with the aluminum wire 10 in the above-described manner, it is possible to solve the problem of low reliability of the conventional electric coil.

Moreover, according to the present invention, the electric coil is formed of an aluminum wire and is connected to each terminal, and thereby it is possible to easily employ the electric coil of the present invention in various electric motors.

As described above, according to the present invention, with the use of an aluminum wire, it is possible to solve the problems of high cost and weight caused by the use of a conventional copper wire, and thus it is possible to reduce the manufacturing cost of the electric coil, which in turn reduces the manufacturing cost of the electric motor.

While the invention has been shown and described with reference to a certain exemplary embodiment thereof, it will be understood by those skilled in the art that various changes in form and details may be made therein without departing from the spirit and scope of the invention as defined by the appended claims.

### INDUSTRIAL APPLICABILITY

As such, the present invention provides an electric coil used in an electric motor, which comprises an aluminum wire including at least two coils and connected in parallel to each other to reduce the high resistance of a conventional aluminum coil to be equal to that of a copper coil, thereby solving the problem of heat generation. Consequently, the present invention can be utilized in various fields which comply with the Green energy policy.

1. An electric coil comprising a wire coated with enamel and spirally wound a predetermined number of times, an insulating member, and an installation member made of plastic,
wherein the wire is an aluminum wire coated with enamel and a copper wire is connected to both ends of the aluminum wire.

2. The electric coil of claim 1, wherein the connecting part between the aluminum wire and the copper wire is covered inside the electric coil with an insulating tube and an insulating tape, thus preventing the connecting part from being exposed to the air.

3. The electric coil of claim 1, wherein the copper wire comprises an insulation coating for coating its conductive wire.

4. The electric coil of claim 1, wherein the connecting part between the aluminum wire and the copper wire is strongly fixed by at least a solder, an insulating tube, and a lap joint.

5. The electric coil of claim 3, wherein the copper wire is connected to a plurality of terminals, respectively, fixed to both sides of the installation member.

6. The electric coil of claim 2, wherein the connecting part between the aluminum wire and the copper wire is strongly fixed by at least a solder, an insulating tube, and a lap joint.
